(19) United States
(12) Patent Application Publication
(10) Pub. No.: US 2024/0093521 A1
(43) Pub. Date: Mar. 21, 2024

(54) DOCKING SYSTEM FOR AUTOMATIC SWIMMING POOL CLEANER

(71) Applicant: ZODIAC POOL CARE EUROPE, Belberaud (FR)

(72) Inventor: Simon Duffaut, Castelginest (FR)

(73) Assignee: ZODIAC POOL CARE EUROPE, Belberaud (FR)

(21) Appl. No.: 18/368,539

(22) Filed: Sep. 14, 2023

Related U.S. Application Data
(60) Provisional application No. 63/406,821, filed on Sep. 15, 2022.

(51) Int. Cl. E04H 4/16; B60L 53/31; E04H 4/14; G05D 1/02

(52) U.S. Cl. CPC E04H 4/1654; B60L 53/31; E04H 4/148; G05D 1/0225; B60L 2200/32; G05D 2201/0203

(57) ABSTRACT

A docking system for an automatic swimming pool cleaner includes a dock and a sensor. The sensor may obtain information about the automatic swimming pool cleaner and/or for controlling the APC or other equipment for a swimming pool or spa. A method includes controlling an automatic swimming pool cleaner based on information obtained by a sensor on a dock of a docking system. A pool system may include a light source on a pool light and/or a user device, and the automatic swimming pool cleaner may be controlled based on a light-based signal from the pool light and/or the user device.

### REFERENCE TO RELATED APPLICATION

This application claims the benefit of U.S. Provisional Patent Application No. 63/406,821, filed on Sep. 15, 2022, and entitled DOCKING SYSTEM FOR AUTOMATIC SWIMMING POOL CLEANER, the content of which is hereby incorporated by reference in its entirety.

### FIELD OF THE INVENTION

The invention relates to systems and apparatuses for cleaning water-containing vessels such as swimming pools and spas and more particularly, although not necessarily exclusively, to automatic swimming pool cleaners (APCs).

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps. While various types of information may be useful for the APC and/or may be desirable to communicate to a user, traditional APCs cannot integrate all sensors due to size constraints on the APC as well as constraints on the sensors such as fragility of the sensor, type of sensor, costs associated with sensors and/or integrating such sensors on an APC, operating environment constraints, etc.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a docking system for an APC includes a dock with a sensor.

According to some embodiments, a method of controlling an APC includes using information from a sensor of a docking system to control the APC.

According to various embodiments, a docking system for an APC includes a sensor for gathering information used to control the APC or other equipment for a swimming pool or spa.

According to certain embodiments, a docking system for an APC includes a sensor for gathering information about a swimming pool or spa and for communicating such gathered information to an external device.

According to various embodiments, a docking system for an APC is self-powered.

According to certain embodiments, a pool system includes a docking system and an APC, and the docking system may communicate with the APC via light-based communication.

According to some embodiments, a pool system includes a pool light and an APC, and the pool light may emit a LiFi signal for controlling the APC.

According to certain embodiments, a pool system includes a pool light and an APC, and the pool light may communicate with the APC via light-based communication.

According to some embodiments, a pool system includes an APC which may receive information from a user device via light-based communication.

According to various embodiments, a method of controlling an APC includes receiving data via light-based communication and controlling the APC based on the data from the light-based communication.

According to some embodiments, a method of controlling an APC includes communicating with the APC via a LiFi signal from a pool light.

According to certain embodiments, a method of controlling an APC includes communicating with the APC via a LiFi signal from a user device.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a docking system for an APC according to embodiments.

FIG. 2 illustrates a dock of the docking system of FIG. 1 according to embodiments.

FIG. 3 illustrates a pool system according to embodiments.

### DESCRIPTION OF THE INVENTION

Described herein are docking systems for APCs with one or more sensors for gathering information about and/or relevant to the APC and/or equipment for the swimming pool or spa. The docking systems described herein may also communicate such gathered information to the APC and/or to a user using various techniques as desired. The information gathered by the docking systems described herein advantageously may be used to control the APC and/or other equipment associated with the swimming pool or spa. Various other benefits and advantages may be realized with the devices and methods provided herein, and the aforementioned advantages should not be considered limiting.

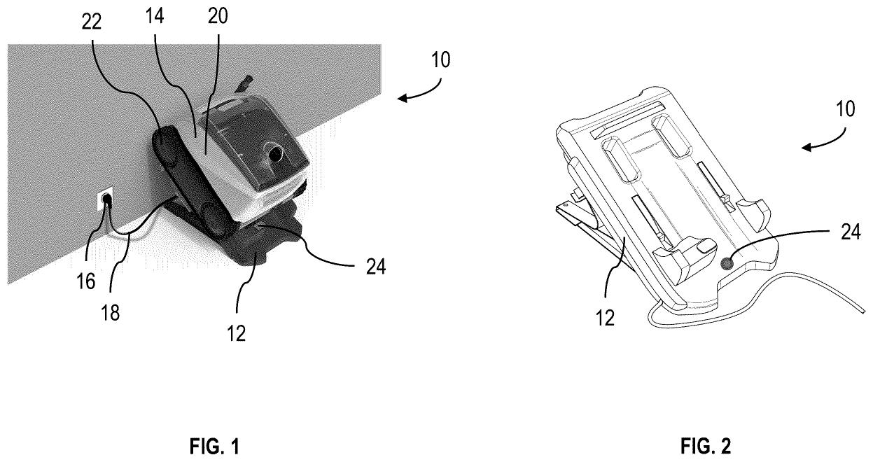

FIGS. 1 and 2 illustrate an example of a docking system 10 according to embodiments. The docking system 10 includes a dock 12, and an APC 14 may be supported on the dock 12.

The APC 14 generally includes a body 20 and one or more motive elements 22 (e.g., wheels, tracks, feet, etc.). A pump, filter assembly, cleaning device such as a brush assembly or other suitable device, any suitable electric or other motors, a controller (e.g., processor and memory), a communication module, an on-board power source (e.g., rechargeable batteries), and/or various other features may be provided on or within the APC 14 as desired. The APC 14 may be various types of APCs as desired, and the particular APC 14 illustrated should not be considered limiting. Other non-limiting examples of APCs 14 may include those described in U.S. Pat. Nos. 10,316,534, 9,488,154, 8,578,538, and U.S. Patent Publication No. 2014/0303810, all of which are hereby incorporated by reference in their entireties.

The dock 12 optionally may include one or more electrical contacts (not shown) for selectively charging or re-charging a battery of the APC 14 as desired and based on contact between the APC 14 and the electrical contacts. The dock 12 may instead or additionally be capable of charging the APC 14 via inductive charging. In such embodiments, the docking system 10 may be a charging system. Optionally, and as illustrated in FIG. 1, the dock 12 may be connected to a power source 16 via a cord 18 or other suitable mechanism or device. In other embodiments, the docking system 10 includes means for generating electricity via renewable energy, and/or the docking system 10 may be a self-powered docking system. As a non-limiting example, the docking system 10 may include a solar panel for generating electricity on the dock 12 and/or otherwise associated with the dock 12. In other embodiments, the docking system 10 need not charge the APC 14 and may just support the APC 14 while not in use and/or as otherwise desired.

In various embodiments, the dock 12 includes one or more sensors 24. Optionally, the dock 12 includes a controller (processor and/or memory) and/or a communication module.

The one or more sensors 24 may be provided at various locations on and/or relative to the dock 12 as desired. The one or more sensors 24 may be various types of sensors as desired for gathering information about and/or relevant to the APC and/or equipment for the swimming pool or spa. As some non-limiting examples, the one or more sensors 24 may be various types of water sensors, including but not limited to oxidation-reduction potential (ORP) sensors, pH sensors, temperature sensors, conductivity sensors, salinity sensors, combinations thereof, and/or other types of water sensors as desired. In such embodiments, the water sensors may analyze water released by the APC 14 after a cleaning cycle and/or may analyze the water of the pool itself if the dock 12 is installed within a portion of the pool or spa. As another non-limiting example, the one or more sensors 24 may be weight sensors such as a scale, and the one or more sensors 24 may measure weight variation of the cleaner (e.g., to determine a quantity of debris extracted from the pool, etc.). As yet another non-limiting example, the one or more sensors 24 may be a geolocation sensor (e.g., a global positioning system sensor, etc.) for facilitating a determination of location of the docking system 10. In another non-limiting example, the one or more sensors 24 may be environmental sensors such as wind sensors, temperature sensors, rain sensors, etc. providing information about environmental conditions in which the docking system 10 is provided. In a further non-limiting example, the one or more sensors 24 may be a sensor for the means for generating electricity via renewable energy. As an example, the one or more sensors 24 may be luminosity sensors if the dock 12 includes the solar panel. The aforementioned sensors 24 are for illustrative purposes only and should not be considered limiting, and in other embodiments, other types of sensors and/or combinations of sensors may be used as desired.

The information gathered by the one or more sensors 24 of the docking system 10 may be communicated using various techniques as desired. In one non-limiting example, the docking system 10 may communicate the information to the APC 14 based on electrical contact between the APC 14 and the dock 12 (e.g., via the electrical contacts) and using a suitable communication protocol (e.g., UART, LIN, etc.). Additionally, or alternatively, the dock 12 may wirelessly communicate (e.g., Bluetooth, WiFi, LiFi, etc.) using the communication module. In such embodiments, the dock 12 may wirelessly communicate with the APC 14, other equipment for the swimming pool or spa, and/or to an external device (e.g., personal electronic device, smartphone, etc.). Additionally, or alternatively, the docking system 10 includes an interface device for receiving and/or providing information. Non-limiting examples of interface devices include lights, mechanical buttons, switches, screens, speakers, combinations thereof, and/or other human machine interfaces as desired.

The information gathered by the docking system 10 may be used for various processes as desired. In some embodiments, the information may be communicated by the docking system 10 to the APC 14 or other equipment for controlling the APC 14 or other equipment. As a non-limiting example, the APC 14 may receive the information gathered by the one or more sensors 24, and the APC 14 may adapt its cleaning cycles based on such information. Additionally, or alternatively, the information may be communicated by the docking system 10 to a user for informational, diagnostic, and/or other uses as desired. As a non-limiting example, the docking system 10 may communicate a sensed water temperature level to the user such that the user can adjust temperature settings of the swimming pool or spa as desired. As another non-limiting example, the docking system 10 may communicate a sensed water temperature level to a controller such that the controller can control a heater of the swimming pool or spa to reach a predetermined or preset water temperature level if the sensed water temperature level is below the predetermined water temperature level. Various other processes and methods may use the information gathered by the docking system 10, and the aforementioned examples should not be considered limiting.

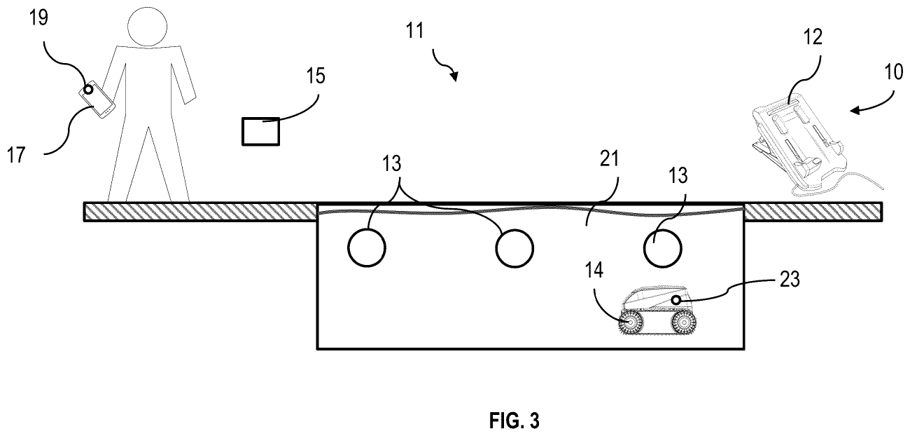

Referring to FIG. 3, in some embodiments, a pool system 11 includes the APC 14 and/or the docking system 10. The pool system 11 may include other components or equipment such as but not limited to one or more pool lights 13 (which may be submerged within a pool 21), heaters, filtration systems, pumps, sanitation systems, combinations thereof, and/or as otherwise desired.

Optionally, the pool system 11 includes a control system 15 (e.g., processing unit and/or memory device) communicatively coupled to one or more pieces of equipment of the pool system 11 using various communication techniques as desired. The processing unit of the control system 15 may be any suitable processing device or combinations of devices including but not limited to one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units, and/or a combination thereof. The one or more memory devices of the control system 15 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the control system 15 optionally includes an associated user interface, including but not limited to a human machine user interface, such that the control system 15 may obtain information from a user and/or provide information to the user via the user interface. When included, the user interface may be on the control system 15 itself or may be at a location remote from the control system 15 such as, but not limited to, another location within the pool system 11. Additionally, or alternatively, the control system 15 optionally may include one or more communication modules such that the control system 15 may receive and/or send information to a user device and/or other location. Non-limiting examples of communication modules may include systems and mechanisms enabling wired communication and/or wireless communication (e.g., near field, cellular, Wi-Fi, Bluetooth®, Bluetooth Low Energy (BLE), low-power wide area network, cloud-based communication etc.). In one non-limiting example, the control system 15 may receive and/or send information to a user device via an application running on the user device.

In various embodiments, and as previously discussed, information may be communicated between various components using various techniques as desired. As non-limiting examples, information may be communicated between the docking system 10 to the APC 14, between the pool lights 13 and the APC 14, between the docking station 10 and the pool lights 13, between the control system 15 and the pool lights 13, combinations thereof, and/or between other equipment of the pool system 11 as desired. Communication between components of the pool system 11 may include sending and/or receiving information.

In some embodiments, the information communicated between components may be utilized to control one or more components of the pool system 11, which advantageously may allow for control of a particular piece of equipment without requiring a direct communication link between such components.

As a non-limiting example, the one or more pool lights 13 may be controlled (e.g., by the control system 15, a user device, etc.) to communicate with the APC 14 via LiFi. In such embodiments, the pool lights 13 themselves may be the LiFi emitter and/or a separate LiFi communication component (e.g., LiFi emitter and/or LiFi receiver) on the pool lights 13 may be utilized. Similarly, the APC 14 may include a LiFi communication component 23 (e.g., LiFi receiver and/or a LiFi transmitter). In various examples, the data in the LiFi signal from the one or more pool lights 13 may be various control responses and/or otherwise cause the APC 14 to perform various actions such as but not limited to changing an operation mode of the APC 14, starting a cleaning cycle, halting a cleaning operation, climbing a surface, moving to a particular location in the pool system 11, returning to the docking system 10, combinations thereof, and/or various other control responses as desired.

As another non-limiting example, a user's device 17, such as but not limited to a smartphone, tablet, computer, personal electronic device, and/or other external devices as desired, may include a light source 19 such as but not limited to a light emitting diode (LED). Optionally, an application running on the user's device 17 (optionally in communication with the control system 15) may control the light source 19 of the user's device 17 to communicate with the APC 14 (or other equipment) via LiFi to send and/or receive data from the APC 14 (or other equipment). In various embodiments, the LiFi communication with the APC 14 (or other equipment) using the light source 19 of the user device 17 optionally may be controlled to transmit data at a lower frequency and/or to communicate less information. Transmitting data at a lower frequency and/or transmitting less information may allow the light source 19 of the user device 17 to communicate with the APC 14 (or other equipment) even if the power of the light source 19 is be limited (e.g., due to the construction of the user device 17 and/or operating constraints of the user device 17). Optionally, communicating with the APC 14 (or other equipment) using LiFi and using the light source 19 of the user device 17 may eliminate a need for a dedicated LiFi emitter within the pool system 11 and/or may provide a solution enabling remote communication to equipment of the pool system 11 with less required features.

Exemplary concepts or combinations of features of the invention may include:
A. A docking system for an APC comprising a dock with a sensor.
B. The docking system of any preceding or subsequent statement or combination of statements, wherein the sensor is configured to gather information about the APC and/or for controlling the APC or other equipment for a swimming pool or spa.
C. The docking system of any preceding or subsequent statement or combination of statements, wherein the sensor comprises one or more of a water sensor, a weight sensor, a position sensor, or an environmental sensor.
D. The docking system of any preceding or subsequent statement or combination of statements, wherein the dock further comprises electrical contacts, and wherein the docking system is configured to communicate with the APC based on contact with the electrical contacts.
E. The docking system of any preceding or subsequent statement or combination of statements, wherein the dock further comprises a communication module for wireless communication, wherein the dock is configured to wirelessly communicate with the APC.
F. The docking system of any preceding or subsequent statement or combination of statements, wherein the dock comprises an interface device for communicating with a user.
G. The docking system of any preceding or subsequent statement or combination of statements, wherein the interface device comprises one or more of a light source, a button, a screen, a speaker, or a communication module for wirelessly communicating with a user device.
H. The docking system of any preceding or subsequent statement or combination of statements, further comprising a powering source for charging the APC.
I. The docking system of any preceding or subsequent statement or combination of statements, further comprising a powering source sensor.
J. A method of controlling an APC, the method comprising using information from a sensor of a docking system to control the APC.
K. The method of any preceding or subsequent statement or combination of statements, further comprising communicating the information from the docking system to the APC based on contact between the APC and a dock of the docking system or via wireless communication.
L. A docking system for an APC, the docking system comprising a sensor for gathering information used to control the APC or other equipment for a swimming pool or spa.
M. A docking system for an APC, the docking system comprising a sensor for gathering information about a swimming pool or spa and for communicating such gathered information to an external device.
N. A docking system for an APC, wherein the docking station is self-powered.
O. The docking system of any preceding or subsequent statement or combination of statements, wherein the docking station comprises one or more solar panels.
P. A pool system comprising a docking system and an APC, wherein the docking system is configured to communicate with the APC via light-based communication.
Q. A pool system comprising a pool light and an APC, wherein the pool light is configured to emit a LiFi signal for controlling the APC.
R. A pool system comprising a pool light and an APC, wherein the pool light is configured to communicate with the APC via light-based communication.
S. A pool system comprising an APC, wherein the APC is configured to receive information from a user device via light-based communication.
T. A pool system of any preceding or subsequent statement or combination of statements, wherein the light-based communication is LiFi communication.
U. A pool system comprising a light source and an APC, wherein the light source is configured to communicate with the APC via light-based communication.
V. The pool system of any preceding or subsequent statement or combination of statements, wherein the light source is a pool light.
W. The pool system of any preceding or subsequent statement or combination of statements, wherein the pool light is an underwater pool light.
X. The pool system of any preceding or subsequent statement or combination of statements, wherein the light source is a light on a user device.
Y. The pool system of any preceding or subsequent statement or combination of statements, wherein the light-based communication comprises LiFi communication.
Z. A method of controlling an APC, the method comprising receiving data via light-based communication and controlling the APC based on the data from the light-based communication.
AA. A method of controlling an APC, the method communicating with the APC via a LiFi signal from a pool light.
BB. A method of controlling an APC, the method communicating with the APC via a LiFi signal from a user device.
CC. The method of any preceding or subsequent statement or combination of statements, wherein communicating via the LiFi signal comprises communicating via a low-frequency LiFi signal.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

1. A docking system for an automatic swimming pool cleaner (APC) comprising a dock with a sensor.

2. The docking system of claim 1, wherein the sensor is configured to obtain information about the APC.

3. The docking system of claim 1, wherein the sensor is configured to obtain information for controlling the APC or other equipment for a swimming pool or spa.

4. The docking system of claim 1, wherein the sensor comprises one or more of a water sensor, a weight sensor, a position sensor, or an environmental sensor.

5. The docking system of claim 1, wherein the dock further comprises electrical contacts, and wherein the docking system is configured to communicate with the APC based on contact with the electrical contacts.

6. The docking system of claim 1, wherein the dock further comprises a communication module for wireless communication, wherein the dock is configured to wirelessly communicate with the APC.

7. The docking system of claim 7, wherein the dock is configured to wirelessly communicate with the APC via LiFi communication.

8. The docking system of claim 1, wherein the dock comprises an interface device for communicating with a user, wherein the interface device comprises one or more of a light source, a button, a screen, a speaker, or a communication module for wirelessly communicating with a user device.

9. (canceled)

10. The docking system of claim 1, further comprising a powering source for charging the APC.

11. The docking system of claim 10, further comprising a powering source sensor.

12. The docking system of claim 1, wherein the docking station is self-powered.

13. A method of controlling an APC, the method comprising using information from a sensor of a docking system to control the APC.

14. The method of claim 13, further comprising communicating the information from the docking system to the APC based on contact between the APC and a dock of the docking system.

15. The method of claim 13, further comprising communicating the information from the docking system to the APC via wireless communication.

16. The method of claim 15, wherein the wireless communication comprises LiFi communication.

17. A pool system comprising a light source and an APC, wherein the light source is configured to communicate with the APC via light-based communication.

18. The pool system of claim 17, wherein the light source is a pool light.

19. The pool system of claim 18, wherein the pool light is an underwater pool light.

20. The pool system of claim 17, wherein the light source is a light on a user device.

21. The pool system of claim 17, wherein the light-based communication comprises LiFi communication.
